(19) United States
(12) Patent Application Publication
(10) Pub. No.: US 2017/0321070 A1
(43) Pub. Date: Nov. 9, 2017

(54) FLUORORESIN POLYMER-METALLIC OXIDE MIXED DISPERSION AND METHOD MANUFACTURING THE SAME

(71) Applicant: JAPAN MATEX CO., LTD., Osaka (JP)

(72) Inventors: Katsuro Tsukamoto, Sennan-shi (JP); Yuzo Nakamura, Sennan-shi (JP); Yuhi Hosoi, Sennan-shi (JP); Fujio Mizukami, Sennan-shi (JP); Taketoshi Kuroda, Kakogawa-shi (JP); Masaki Terao, Kakogawa-shi (JP)

(73) Assignee: JAPAN MATEX CO., LTD., Osaka (JP)

(21) Appl. No.: 15/587,619

(22) Filed: May 5, 2017

(30) Foreign Application Priority Data
May 9, 2016 (JP) 2016-094163
Apr. 4, 2017 (JP) 2017-074860

(51) Int. Cl. C09D 7/12; C08J 3/05; C08K 3/22

(52) U.S. Cl. CPC C09D 7/1216; C08J 3/05; C08K 2003/2241; C08K 2003/2213; C08K 3/22; C08J 2327/12; C08K 2003/2244; C08K 2003/221

(57) ABSTRACT

A fluororesin-metal oxide mixed dispersion (sol) with excellent operability and workability provided in a coating step is obtained by mixing aqueous dispersion of fluororesin particle, and particle sol of metal oxide with suitable pH value that is any one of titanium oxide, zirconium oxide, lanthanum oxide, neodymium oxide, cerium oxide, or tin oxide. Both the fluororesin particle and the metal oxide particle float and disperse without coagulation precipitation, gelation and solidification, and/or phase separation. The floating and dispersion state is stably maintained under room temperature storage for three days or more. Water contact angle of a solid product obtained by evaporation and scattering of a solvent from the fluororesin-metal oxide mixed dispersion is 130 degrees or less, and surface resistivity is 2.0×10¹²Ω/□ (ohm/square) or less.

### BACKGROUND OF THE INVENTION

### Field of the Invention

The present invention relates to a coating liquid for coating the surfaces of various kinds of materials such as metal, carbon, plastics, glass, ceramics, and wood, and the surfaces of products made of these materials, a liquid for impregnating fibers and powders of the above-described materials, and a method of manufacturing the liquids.

### Description of Related Art

A fluororesin has excellent heat and cold resistance, has high resistance to various medicines including an acid or an alkali, i.e., high chemical resistance and corrosion resistance, has also incombustible property, provides high electric insulation and low dielectric loss, provides nonadhesive and nonwettable characteristics so that it can repel water and oil, and provides low friction property and proper elasticity, compared with general plastics and organic high polymers, such as polyethylene and polypropylene. Accordingly, the fluororesin can be used for coating the surfaces of various materials and products, such as a mold material, a container, an electric wire, a thermometer, various sensors, a gasket, a packing, and a frying pan.

These coatings are usually performed, for example, by lining of a fluororesin film, coating and impregnation of the fluororesin particle dispersion. Various kinds of such fluororesin films and dispersions are commercially available and new products also have been developed (for example, see Japanese Unexamined Patent Application Publication No. 2006-117900).

While the fluororesin is incombustible and has excellent heat resistance as compared to the other organic polymers, it is softer than the other organic high polymer resin, which makes it difficult to constantly keep the size of the fluororesin at the time of molding and to perform surface treatment, such as coating and modification useful for multifunctionalization and high functionalization.

The fluororesin is also an extremely excellent insulting material, and thus is very easy to charge and ranked as the most negatively-chargeable substance in the triboelectric series. Electrification can cause ignition and explosion of combustible gas and a solvent, and insulation breakdown of the fluororesin product itself. Accordingly, a measure to prevent electrification and eliminate static electricity of the fluororesin is significantly important.

While the elimination of the electrification is usually performed by connecting a ground to the fluororesin and a product thereof, or mixing a conductive substance with the fluororesin, such methods may often be difficult.

For example, while surface coating or modification is a frequently performed operation or step for multifunctionalization and high performance, the surface repels a coating liquid containing the fluororesin due to its property to be strongly charged significantly easily, which often leads to failure of coating.

In such a case, it is possible to use the ground instead, which, however, results in low workability. If the present conductive substances, i.e., carbon black (CB), carbon fiber (CF) and carbon nanotube (CNT), and metal fine powders are mixed, the surface formed by the mixing may not be suitable to subsequent coating or modification.

While the nonwettable and nonadhesive characteristics of the fluororesin provides great advantage of being stain-resistant, it causes a significant problem that a coating liquid used for surface coating and modification can be easily repelled by the surface.

To plastics consisting of organic high polymers is usually added an additive (filler), in order to enhance its processability, weather resistance, durability, stiffness, shock resistance, slidability, wear resistance, fire retardancy, heat resistance, sound insulation, gas barrier property, or the like, or in order to improve surface properties, such as antistatic property and friction.

The filler includes various kinds of particulates and fibers of metal oxide and metal, in particular, talc, mica, silicon oxide (silica), titania, alumina, magnesia, graphite, molybdenum sulfide, calcium carbonate, and iron powder, and are selected and used according to purposes and measures (Journal of The Society of Rubber Science and Technology, Japan, the 75th volume, No. 8, 330-332 (2002); Plastics Age, April Issue, 2006, 72-80; and Journal of The Society of Rubber Science and Technology, Japan, the 82nd volume, No. 2, 61-66 (2009)).

For example, talc, silica, calcium carbonate, alumina, montmorillonite, synthetic mica, or the like is used for dynamic/thermal reinforcement as a filler. Further, as a filler, CB, CNT, metal powder, or the like is used for a measure against electromagnetic waves and static electricity; silica, boron nitride, or the like is used for a measure against high frequency; aluminium nitride, boron nitride, alumina, or the like is used for heat dissipation; aluminium hydroxide, magnesium hydroxide, antimony oxide, hydrotalcite, silica, or the like is used for fire retardation; montmorillonite, synthetic mica, or the like is used for a gas-barrier measure; silica, talc, calcium carbonate, or the like is used for an anti-blocking measure; silver zeolite, silver, silica, or the like is used for bactericidal and antibacterial purposes, respectively (Plastics Age, April Issue, 2006, 72-80).

An inorganic filler in the fluororesin is usually glass fiber, carbon fiber, graphite, carbon, CNT, molybdenum disulfide, silica, or the like that are added mainly for improving and enhancing wear resistance, compressive resistance, cold flow resistance, slidability, conductivity, or the like.

However, these are not designed for reforming surface property for multifunctionalization and high functionalization of the fluororesin, such as adjustment and improvement of wettability, adhesiveness, and electrostatic property, and thus are far from suited to the surface property reforming.

Generally, a solid molding such as powder, film, and coating film of fluororesin is obtained by evaporating water from aqueous dispersion of the fluororesin particle and then drying the resultant product. In such an operation/step, it is preferable that a filler component is pre-added to and pre-mixed with aqueous dispersion of fluororesin particle (emulsion) to form a mixed and uniformly-dispersed solution of fluororesin particles and the filler component (additive).

However, there are very few kinds of additives which can be added to or mixed with aqueous dispersion of fluororesin particle to form a mixed and uniformly-dispersed solution.

Japanese Unexamined Patent Application Publication No. 2007-119769; Japanese Unexamined Patent Application Publication No. 2008-115335; and Japanese Unexamined Patent Application Publication No. 2008-115336 disclose colloidal sol solution of an inorganic particle as an additive that is mixed with fluororesin emulsion and uniformly disperses. Specifically, the additive includes silica, titanium oxide, zeolite, aluminium oxide (alumina), zinc oxide, antimony pentoxide, silicon carbide, silicon nitride, aluminium nitride, lead oxide, tin oxide, magnesium oxide, or the like, and many kinds of the additives are suited to preparation of a solution where they are mixed with fluororesin emulsion and uniformly dispersed.

However, in the examples of the above-described patent documents, all the preparation of the mixed and uniformly-dispersed solutions are limited to silica, and no example of the above-described colloidal solution of the inorganic particle other than silica is described. There is no description of property, composition, or constitution of the sol of the inorganic particle to be used for the mixture, and only substance names of the inorganic particle sol are described.

Accordingly, most of the additives that are mixed with fluororesin emulsion and uniformly dispersed are silica sol and organo silicate solutions having excellent viscosity stability, and alumina sol is only limitedly known (Japanese Unexamined Patent Application Publication No. 2006-117900; Japanese Unexamined Patent Application Publication No. 2007-119769; Japanese Unexamined Patent Application Publication No. 2008-115335; Japanese Unexamined Patent Application Publication No. 2008-115336; Japanese Unexamined Patent Application Publication No. 08-258228; and Japanese Unexamined Patent Application Publication No. 2012-219126).

These addition is intended to improve mechanical strength, heat resistance, dimensional stability, compressive creep property, and melt moldability of the finally-obtained fluororesin solid, but not to reform or adjust surface property. The mixed dispersion available for reforming and adjusting surface property of the fluororesin are very difficult to obtain.

For the reason as described above, research and technical development of a filler (additive) designed for reforming surface property of fluororesin for multifunctionalization and high functionalization, in particular, for adjustment and improvement of wettability, adhesiveness, and electrostatic property have not been sufficiently advanced. The same thing can be applied to not only a solid such as powder, film, and coating membrane of the fluororesin and a solid molding thereof, but also aqueous dispersion of fluororesin particle from which they derive.

### SUMMARY OF THE INVENTION

The present invention aims to solve the above-described problems of the prior art. The present inventors widely searched for a combination of aqueous dispersion of fluororesin particles or emulsion and a metal oxide colloidal zol, and repeated a process of trials and errors with extensive research in order to find a suitable method of combining and preparing the best combinations. Finally, they succeeded in developing a mixed dispersion (sol) where fluororesin particles and metal oxide particles are uniformly float and disperse in an aqueous solvent, which enables adjustment and improvement of the wettability, adhesiveness, and electrostatic property of surfaces of a solid, such as finally-obtained powder, film, and coating membrane of the fluororesin.

The invention according to a first aspect relates to a fluororesin-metal oxide mixed aqueous dispersion obtained by mixing aqueous dispersion of fluororesin particle, and particle sol of metal oxide with suitable pH value that is any one of titanium oxide, zirconium oxide, lanthanum oxide, neodymium oxide, cerium oxide, or tin oxide, wherein both the above-described fluororesin particle and the above-described metal oxide particle float and disperse without coagulation precipitation, gelation and solidification, and/or phase separation, wherein the above-described floating and dispersion state is stably maintained under room temperature storage for three days or more, wherein water contact angle of a solid product obtained by evaporation and scattering of a solvent from the fluororesin-metal oxide mixed dispersion is 130 degrees or less, and surface resistivity is 2.0×10¹²Ω/□ (ohm per square) or less. Dimension of surface resistivity is the same as that of electric resistance and thus its unit is generally expressed as O. In the specification, Ω/□ (Ω/sq., ohms per square) described herein is used as the unit of surface resistivity to avoid any confusion with the electric resistance. Ω/□ represents surface resistivity measured when an electric current flows from one end to the opposite end on an arbitrarily sized square-shaped area.

The invention according to a second aspect relates to the fluororesin-metal oxide mixed aqueous dispersion of the first aspect, wherein the above described suitable pH value of the metal oxide particle sol is 2.5-13.5 if the metal oxide is titanium oxide, 6.5-9 if the metal oxide is zirconium oxide, 7-10 if the metal oxide is lanthanum oxide, 7-10 if the metal oxide is neodymium oxide, 6.5-9.5 if the metal oxide is cerium oxide, or 9-11 if the metal oxide is tin oxide.

The invention according to a third aspect relates to the fluororesin-metal oxide mixed aqueous dispersion of the first or second aspect, wherein the above-described fluororesin-metal oxide mixed aqueous dispersion contains 3 to 100 times of fluororesin particle and 5 to 120 times of water in weight ratio with respect to the content of the above-described metal oxide particle in the above-described dispersion.

The invention according to fourth aspect relates a method of manufacturing the fluororesin-metal oxide mixed aqueous dispersion of any of the first to third aspects, comprising a step of mixing aqueous dispersion of fluororesin particle, and particle sol of metal oxide with suitable pH value that is any one of titanium oxide, zirconium oxide, lanthanum oxide, neodymium oxide, cerium oxide, or tin oxide under normal pressure at the temperature of 5 to 100° C., wherein fluororesin particle is present at 3 to 100 times and water is present at 5 to 120 times in weight ratio with respect to the content of the above-described metal oxide particle in the dispersion.

The invention according to fifth aspect relates the method of manufacturing the fluororesin-metal oxide mixed aqueous dispersion of the fourth aspect, wherein the above described suitable pH value of the metal oxide particle sol is 2.5-13.5 if the metal oxide is titanium oxide, 6.5-9 if the metal oxide is zirconium oxide, 7-10 if the metal oxide is lanthanum oxide, 7-10 if the metal oxide is neodymium oxide, 6.5-9.5 if the metal oxide is cerium oxide, or 9-11 if the metal oxide is tin oxide.

### EFFECT OF THE INVENTION

In the fluororesin-metal oxide mixed dispersion of the present invention, particles of the fluororesin and metal oxide do not aggregate or assemble so that they do not precipitate, and are mixed and uniformly dispersed in an aqueous solvent in their original size or a size close to the original size even if they somewhat aggregated, i.e., a size where they can float and disperse in the aqueous solvent against gravity. Thus, after the mixed dispersion of the present invention is applied to, impregnated or dipped in a coated object, metal oxide-added fluororesin (Teflon (registered trademark)) layered coating can be applied with any thickness and even with no gap between the particles because accurate accumulation of the particles occurs, through simple operation and work of drying and heat treating.

Also, since the operation and work using the mixed dispersion of the present invention are simple, they are energy saving, very safe, and also extremely excellent from an economical perspective.

### DETAILED DESCRIPTION OF THE INVENTION

### Constitution of the Fluororesin-Metal Oxide Mixed Dispersion

The fluororesin-metal oxide mixed dispersion of the present invention is an aqueous dispersion, usually comprising a fluororesin particle, a metal oxide particle, and water, wherein the fluororesin particle and the metal oxide particle float and disperse in the dispersion. Components of the fluororesin-metal oxide mixed dispersion are not limited to these components but may include other components.

The fluororesin particle herein is preferably a resin particle comprising a polymer of monomer or a copolymer thereof selected from tetrafluoroethylene, hexafluoropropylene, chlorotrifluoroethylene, perfluoro (alkyl vinyl ether), vinylidene fluoride, and vinyl fluoride, etc., and those dispersed in water among the particles are conveniently used for preparation of the fluororesin-metal oxide mixed dispersion of the present invention.

In addition, monomers other than the above-mentioned monomers or copolymers thereof may be used as long as they disperse in water.

The metal oxide particle of the present invention means titanium oxide (titania), zirconium oxide (zirconia), lanthanum oxide (lanthana), neodymium oxide, cerium oxide (ceria), and tin oxide. An aqueous colloidal sol of these particles is used to obtain a fluororesin-metal oxide mixed dispersion of the present invention.

For the fluororesin particle and the metal oxide particle, the particle becomes increasingly settled down or precipitated as the size becomes larger. Therefore, in order for the particles of the fluororesin and the metal oxide to maintain their floating and dispersing state in the aqueous solvent for a long period of time, their particle sizes are preferably small.

More particularly, fluororesin particle has an average particle size of primary particle preferably in a range of 0.1-0.5 μm, and metal oxide particle has an average particle size of primary particle preferably in a range of 2-150 nm, more preferably 2-50 nm. However, if the floating and dispersing state can be maintained in the aqueous solvent for a long period of time, the particle sizes of the fluororesin and the metal oxide are not limited to the above ranges. The average particle size of the metal oxide particle is a median size when measured by “LB-500 Dynamic Light-Scattering Particle Size Analyzer” manufactured by HORIBA.

For uniform floating and dispersion of the particle in the solvent, not only affinity with the solvent but also consideration and idea for not allowing aggregation of the particles are important. It is because that the aggregation increases viscosity and thus solidification and gelation occur to induce precipitation. Therefore, it is necessary to prevent assembly and aggregation of the particles. The measures for the prevention include, for example, allowing the particles to have the same electric charge (to be electrically charged) and repulse each other, and surrounding the particles with surfactant to form a composite micelle.

In the case of the metal oxide colloid, if the micelles are formed, the particles are repulsed each other by charging and dispersed in many of the micelles.

Generally, a charge amount of a particle is closely related to pH of solution and extremely sensitive to pH. Therefore, pH of a metal oxide sol used for preparation of the fluororesin-metal oxide mixed dispersion of the present invention also has an appropriate range for preventing the aggregation, which varies depending on metal species.

The pH of the metal oxide sol used in the present invention is desirable to be 2.5-13.5, preferably 3-13 for titania, 6.5-9, preferably 7-8.5 for zirconia, 7-10, preferably 7.5-9.5 for Lantana, 7-10, preferably 7.5-9.5 for neodymium oxide, 6.5-9.5, preferably 7-9 for ceria, and 9-11, preferably 9.5-10.5 for tin oxide.

The pH of the aqueous dispersion of the fluororesin particle used for preparation of the fluororesin-metal oxide mixed dispersion is desirable to be generally 7-11.

The pH range of the fluororesin-metal oxide mixed dispersion is preferably 1-13. The above-mentioned pH range is more preferably 3-12. Types and amounts of the aqueous dispersion of the fluororesin particle and the metal oxide sol are desirable to be appropriately set so that the pH range of the fluororesin-metal oxide mixed dispersion obtained by mixing both falls within the above-mentioned range and that characteristics such as predetermined dispersion stability can be obtained. If the pH of the obtained fluororesin-metal oxide mixed dispersion is deviated from the range of 1-13, it is preferable to adjust the pH to fall within the above-mentioned pH range using an appropriate acid or alkali.

Stably maintaining the floating and dispersing state of the fluororesin-metal oxide mixed dispersion as described herein means maintaining a state where both the fluororesin particle and metal oxide particle in the fluororesin-metal oxide mixed dispersion float and disperse without any coagulation precipitation, gelation and solidification, and/or phase separation under storage conditions at room temperature for at least three days.

The fluororesin-metal oxide mixed dispersion according to the present invention has characteristics that a water contact angle of a solid obtained at the time of evaporation and scattering of a solvent from the fluororesin-metal oxide mixed dispersion is 130 degrees or less and surface resistivity thereof is 2.0×10¹²Ω/□ or less. A preferable range of the water contact angle is 120 degrees or less.

Each value of the water contact angle and surface resistivity in the present invention can be obtained by the following measuring methods.

A water contact angle is measured using an automatic contact angle meter with a coating film obtained by applying the fluororesin-metal oxide mixed dispersion on a glass substrate and drying it at 150° C. for 30 minutes. A surface resistivity is measured using a high resistivity meter with a thin film obtained by applying the fluororesin-metal oxide mixed dispersion on the glass substrate with a spin coater (revolution: 16.67 s⁻¹/10 seconds) and ventilating and drying it at 150° C. for 30 minutes.

As described above, addition of surfactant is often very effective in stabilization of the floating and dispersing state of the particle.

The surfactant is selected in the light of affinity with particles of a metal oxide and a fluororesin and solvent, and electrostatic repulsion of a produced composite micelle, etc. But, if the dispersion is obtained by simple mixing of the aqueous dispersion of the fluororesin particle with the metal oxide sol, the surfactant is not an essential ingredient.

However, since the period when the dispersing state is stably maintained by addition of an adequate amount of an appropriate surfactant may be prolonged, the present invention does not exclude addition of surfactant. Rather, surfactant effective for prolongation of stable period, for example, a generally available nonionic surfactant such as polyoxyalkylene alkyl ether and polyoxyalkylene alkylphenyl ether may be used.

When the pH of the fluororesin-metal oxide mixed dispersion is deviated from the range of 1-13 with addition of the surfactant, it is preferable to adjust the pH to fall within the above-mentioned pH range using an appropriate acid or alkali.

When a surfactant exists in the fluororesin-metal oxide mixed dispersion, it maintains the uniform dispersing state by a certain kind of intermolecular association with the fluororesin particle and/or the metal oxide particle, through van der Waals interaction or electrostatic interaction, etc.

Pre-modifying the surface of the fluororesin particle and/or the metal oxide particle with a substance which acts instead of and similar to the surfactant and adding a modifier having such effect to respective dispersion of the fluororesin particle and/or the metal oxide particle may be effective in maintaining the uniform floating and dispersing state of the fluororesin-metal oxide mixed dispersion for a long period of time, and such processing may be performed.

More specifically, the processing includes, but not limited to, for example, modifying the surface of the metal oxide particle with a silane coupling agent, etc. and adding the silane coupling agent, etc. to the metal oxide particle sol, and a typical modification method may be used instead.

Aggregation of particles is closely related to their concentration.

As the concentration increases, viscosity increases. The particle is more likely to solidify and gelate as well as aggregate and precipitate. Therefore, lowering of concentration of both the fluororesin particle and the metal oxide particle in the dispersion, i.e., low particle concentration, is effective in achieving the mixing and uniform dispersing state of the fluororesin particle and the metal oxide particle in the fluororesin-metal oxide mixed dispersion and retaining the state for a long period of time.

However, if the particle concentration is low, a film obtained by operation such as application and impregnation is thin and relatively large energy will be consumed to evaporation and scattering of a solvent in heat treatment processes such as drying and burning, which is uneconomical. Thus, from this viewpoint, higher particle concentration is preferable.

From such viewpoint, the fluororesin-metal oxide mixed dispersion preferably contains, but not limited to, 3-100 times of fluororesin particles and 5-120 times of water in the weight ratio with respect to the content of the metal oxide particle in the dispersion, and any weight ratio may be selected in order to obtain desired characteristics.

### Method of Manufacturing a Fluororesin-Metal Oxide Mixed Dispersion

The fluororesin-metal oxide mixed dispersion according to the present invention is prepared by mixing an aqueous dispersion of the fluororesin particle and a metal oxide particle sol under stirring.

This mixed dispersion is preferably prepared so that it contains 3-100 times of fluororesin particles and 5-120 times of water in the weight ratio with respect to the content of the metal oxide particle.

There is no particular regulation on the stirring in the mixing. Optimal stirring conditions are suitably selected in consideration of particle concentration, viscosity of a mixed dispersion, and solution temperature, etc. at the time of mixing.

While temperature at the time of stirring is usually a room temperature, it can be lowered below the room temperature in consideration of viscosity of the mixed dispersion, etc. and suitably selected depending on the situation.

There is also no particular regulation on pressure at the time of mixing and stirring and they are usually conducted under normal pressure. However, if pressurization or depressurization is necessary in terms of viscosity or concentration of a solvent, pressure can be suitably selected depending on the purpose.

### Materials

In preparation of fluororesin-metal oxide mixed dispersion of the present invention, the following aqueous dispersion or emulsion of fluororesin particle, and colloidal sol of metal oxide particle were used. In this specification, the symbols from A-1 to A-3 and B-1 to B-7 are used.

### Aqueous Dispersion of Fluororesin Particle

A-1: PTFE 31-JR manufactured by Du Pont-Mitsui Fluorochemicals Company, Ltd. (Solid Content of PTFE: 60 wt. %, Average molecular weight: 2×10⁴-1×10⁷, Average particle size of PETE primary particle: 0.1-0.5 μm, pH: 10.5) A-2: Polyflon (Registered trademark) D-111 manufactured by DAIKIN INDUSTRIES, LTD. (Solid Content of PTFE: 60 wt. %, Average molecular weight: 2×10⁴-1×10⁷, Average particle size of PETE primary particle: 0.1-0.5 μm, pH: 9.7)

A-3: Fluon (Registered Trademark) PTFE dispersion AD911E manufactured by ASAHI GLASS CO., LTD. (Solid Content of PTFE: 60 wt. %, Average particle size of PETE primary particle: 0.1-0.5 μm, Average molecular weight: 2×10⁴-1×10⁷, pH: 10)

### Metal Oxide Sol

B-1: Tainoc A-6 manufactured by Taki Chemical Co., Ltd. (wt. % of TiO₂: 6, Average particle size: 20 nm, pH: 12)

B-2: Tainoc AM-15 manufactured by Taki Chemical Co., Ltd. (wt. % of TiO₂: 15, Average particle size: 20 nm, pH: 4)

B-3: Biral Zr-C20 manufactured by Taki Chemical Co., Ltd. (wt. % of ZrO₂: 20, Average particle size: 40 nm, pH: 8)

B-4: Biral La-C10 manufactured by Taki Chemical Co., Ltd. (wt. % of La₂O₃: 10, Average particle size: 40 nm, pH: 8)

B-5: Biral Nd-C10 manufactured by Taki Chemical Co., Ltd. (wt. % of Nd₂O₃: 10, Average particle size: 20 nm, pH: 9)

B-6: Needlal B-10 manufactured by Taki Chemical Co., Ltd. (wt. % of CeO₂: 10, Average particle size: 20 nm, pH: 8)

B-7: Ceramace S-8 manufactured by Taki Chemical Co., Ltd. (wt. % of SnO₂: 8, Average particle size: 8 nm, pH: 10)

### Use of Fluororesin-Metal Oxide Mixed Dispersion

The fluororesin-metal oxide mixed dispersion of the present invention is suitable as a coating liquid for coating the surfaces of materials such as metals, carbons, plastics, glasses, ceramics, or woods and the surfaces of products made of these materials, and as an impregnation liquid for fibers or powders of these materials. Specifically, the mixed dispersion exhibits excellent performance as a coating material for coating the surface of materials or products such as an electric wire, a thermometer, various sensors, a gasket or a packing, and as an undercoating material in multilayer/multistage coating for multifunction and high functionality.

### EXAMPLES

Hereinafter, the present invention will be described in detail with reference to examples, but the invention is not limited by the examples. Surface resistivity and water contact angle of solid content obtained from the fluororesin-metal oxide mixed dispersion shown in the examples were measured as follows, respectively. After the mixed dispersion was spin coated on glass substrate (revolution: 16.67 s⁻¹/10 seconds) and dried with a circulation drier (150° C./30 minutes) to form a thin coating film, surface resistivity of the film was measured using a high resistivity meter (MCP-450 manufactured by Mitsubishi Chemical Corporation). After the mixed dispersion was coated on glass substrate (without any adhesive) or phenolic adhesive-applied SUS substrate and dried (100° C./60 minutes or 150° C./30 minutes) to form a coating film, water contact angle of the film was measured using an automatic contact angle meter (Dms-400 manufactured by Kyowa Interface Science Co., Ltd).

### Influence of Metal Species of Metal Oxide Sol in Fluororesin-Metal Oxide Mixed Dispersion

### Example 1

Aqueous dispersion of fluororesin particle: A-1; 30 g

Metal oxide particle sol: B-1; 24 g

Mixing condition: room temperature and normal pressure

Stirring time: 30 minutes

Result: The prepared fluororesin-titania mixed dispersion did not solidify/gelate, aggregate/precipitate, or separate phases for 15 days or more under storage conditions at room temperature, and viscosity of the dispersion was nearly unchanged after a storage test. Also, since flowability of the mixed dispersion was very satisfactory, the mixed dispersion could be used as a coating liquid or an impregnation liquid for coating fluororesin without any trouble after 15 days.

### Example 2

Aqueous dispersion of fluororesin particle: A-2; 30 g

Metal oxide particle sol: B-1; 24 g

Mixing condition: room temperature and normal pressure

Stirring time: 30 minutes

Result: The prepared fluororesin-titania mixed dispersion did not solidify/gelate, aggregate/precipitate, or separate phases for 15 days or more under storage conditions at room temperature, and viscosity of the dispersion was nearly unchanged after a storage test. Also, since flowability of the mixed dispersion was very satisfactory, the mixed dispersion could be used as a coating liquid or impregnation liquid for coating fluororesin without any trouble after 15 days.

### Example 3

Aqueous dispersion of fluororesin particle: A-3; 30 g

Metal oxide particle sol: B-1; 24 g

Mixing condition: room temperature and normal pressure

Stirring time: 30 minutes

Result: The prepared fluororesin-titania mixed dispersion did not solidify/gelate, aggregate/precipitate, or separate phases for 15 days or more under storage conditions at room temperature, and viscosity of the dispersion was nearly unchanged after a storage test. Also, since flowability of the mixed dispersion was very satisfactory, the mixed dispersion could be used as a coating liquid or impregnation liquid for coating fluororesin without any trouble after 15 days.

### Example 4

Aqueous dispersion of fluororesin particle: A-1; 30 g

Metal oxide particle sol: B-2; 24 g

Mixing condition: room temperature and normal pressure

Stirring time: 60 minutes

Result: The prepared fluororesin-titania mixed dispersion did not solidify/gelate, aggregate/precipitate, or separate phases for 5 days or more under storage conditions at room temperature, and viscosity of the dispersion was nearly unchanged after a storage test. Also, since flowability of the mixed dispersion was very satisfactory, the mixed dispersion could be used as a coating liquid or impregnation liquid for coating fluororesin without any trouble after 5 days.

### Example 5

Aqueous dispersion of fluororesin particle: A-2; 30 g

Metal oxide particle sol: B-2; 24 g

Mixing condition: room temperature and normal pressure

Stirring time: 60 minutes

Result: The prepared fluororesin-titania mixed dispersion had pH of 4.8, did not solidify/gelate, aggregate/precipitate, or separate phases for 5 days or more under storage conditions at room temperature, and viscosity of the dispersion was nearly unchanged after a storage test. Also, since flowability of the mixed dispersion was very satisfactory, the mixed dispersion could be used as a coating liquid or impregnation liquid for coating fluororesin without any trouble after 5 days.

Water contact angle of a coating film formed on glass substrate (drying: 150° C./30 minutes) or phenolic adhesive-applied SUS substrate (drying: 100° C./60 minutes or 150° C./30 minutes) using the prepared fluororesin-titania mixed dispersion were 90.7 degrees, 105.3 degrees and 102.9 degrees, respectively. These angles were significantly lower than the angle: 130-140 degrees of fluororesin film, PTFE membrane. In addition, surface resistivity of the film formed on glass substrate (drying: 150° C./30 minutes) by spin coating method was 6.9×10¹¹Ω0/□, which was significantly lower than the resistivity: 2.5×10¹²Ω/□ of the film obtained from the mixed dispersion of fluororesin particle (A-2: polyflon D-111 manufactured by DAIKIN INDUSTRIES, LTD) under the same conditions.

### Example 6

Aqueous dispersion of fluororesin particle: A-3; 30 g

Metal oxide particle sol: B-2; 24 g

Mixing condition: room temperature and normal pressure

Stirring time: 60 minutes

Result: The prepared fluororesin-titania mixed dispersion did not solidify/gelate, aggregate/precipitate, or separate phases for 5 days or more under storage conditions at room temperature, and viscosity of the dispersion was nearly unchanged after a storage test. Also, since flowability of the mixed dispersion was very satisfactory, the mixed dispersion could be used as a coating liquid or impregnation liquid for coating fluororesin without any trouble after 5 days.

### cl Example 7

Aqueous dispersion of fluororesin particle: A-1; 30 g

Metal oxide particle sol: B-3; 24 g

Mixing condition: room temperature and normal pressure

Stirring time: 30 minutes

Result: The prepared fluororesin-zirconia mixed dispersion did not solidify/gelate, aggregate/precipitate, or separate phases for 10 days or more under storage conditions at room temperature, and viscosity of the dispersion was nearly unchanged after a storage test. Also, since flowability of the mixed dispersion was very satisfactory, the mixed dispersion could be used as a coating liquid or impregnation liquid for coating fluororesin without any trouble after 10 days.

### Example 8

Aqueous dispersion of fluororesin particle: A-2; 30 g

Metal oxide particle sol: B-3; 24 g

Mixing condition: room temperature and normal pressure

Stirring time: 30 minutes

Result: The prepared fluororesin-zirconia mixed dispersion had pH of 8.6, did not solidify/gelate, aggregate/precipitate, or separate phases for 10 days or more under storage conditions at room temperature, and viscosity of the dispersion was nearly unchanged after a storage test. Also, since flowability of the mixed dispersion was very satisfactory, the mixed dispersion could be used as a coating liquid or impregnation liquid for coating fluororesin without any trouble after 10 days.

When the prepared fluororesin-zirconia mixed dispersion was used to form a coating film with the same procedure of the above Example 5, water contact angle of a coating film formed on glass substrate (drying: 150° C./30 minutes) or phenolic adhesive-applied SUS substrate (drying: 100° C./60 minutes or 150 ° C./30 minutes) were 78.3 degrees, 104.8 degrees and 99.3 degrees, respectively, and surface resistivity of a film formed by spin coating method was 2.6×10¹¹Ω/□.

### Example 9

Aqueous dispersion of fluororesin particle: A-3; 30 g

Metal oxide particle sol: B-3; 24 g

Mixing condition: room temperature and normal pressure

Stirring time: 30 minutes

Result: The prepared fluororesin-zirconia mixed dispersion did not solidify/gelate, aggregate/precipitate, or separate phases for 10 days or more under storage conditions at room temperature, and viscosity of the dispersion was nearly unchanged after a storage test. Also, since flowability of the mixed dispersion was very satisfactory, the mixed dispersion could be used as a coating liquid or impregnation liquid for coating fluororesin without any trouble after 10 days.

### Example 10

Aqueous dispersion of fluororesin particle: A-1; 30 g

Metal oxide particle sol: B-4; 24 g

Mixing condition: room temperature and normal pressure

Stirring time: 30 minutes

Result: The prepared fluororesin-lantana mixed dispersion did not solidify/gelate, aggregate/precipitate, or separate phases for 7 days or more under storage conditions at room temperature, and viscosity of the dispersion was nearly unchanged after a storage test. Also, since flowability of the mixed dispersion was very satisfactory, the mixed dispersion could be used as a coating liquid or impregnation liquid for coating fluororesin without any trouble after 10 days.

### Example 11

Aqueous dispersion of fluororesin particle: A-2; 30 g

Metal oxide particle sol: B-4; 24 g

Mixing condition: room temperature and normal pressure

Stirring time: 30 minutes

Result: The prepared fluororesin-lantana mixed dispersion had pH of 9.2, did not solidify/gelate, aggregate/precipitate, or separate phases for 7 days or more under storage conditions at room temperature, and viscosity of the dispersion was nearly unchanged after a storage test. Also, since flowability of the mixed dispersion was very satisfactory, the mixed dispersion could be used as a coating liquid or impregnation liquid for coating fluororesin without any trouble after 10 days.

When the prepared fluororesin-lantana mixed dispersion was used to form a coating film with the same procedure of the above Example 5, water contact angle of a coating film formed on glass substrate (drying: 150° C./30 minutes) or phenolic adhesive-applied SUS substrates (drying: 100° C./60 minutes or 150° C./30 minutes) were 95.9 degrees, 122.8 degrees and 121.4 degrees, respectively, and surface resistivity of a film formed by spin coating method was 2.5×10¹¹Ω/□.

### Example 12

Aqueous dispersion of fluororesin particle: A-3; 30 g

Metal oxide particle sol: B-4; 24 g

Mixing condition: room temperature and normal pressure

Stirring time: 30 minutes

Result: The prepared fluororesin-lantana mixed dispersion did not solidify/gelate, aggregate/precipitate, or separate phases for 7 days or more under storage conditions at room temperature, and viscosity of the dispersion was nearly unchanged after a storage test. Also, since flowability of the mixed dispersion was very satisfactory, the mixed dispersion could be used as a coating liquid or impregnation liquid for coating fluororesin without any trouble after 10 days.

### Example 13

Aqueous dispersion of fluororesin particle: A-1; 30 g

Metal oxide particle sol: B-5; 9 g

Mixing condition: room temperature and normal pressure

Stirring time: 60 minutes

Result: The prepared fluororesin-neodymium oxide mixed dispersion did not solidify/gelate, aggregate/precipitate, or separate phases for 7 days or more under storage conditions at room temperature, and viscosity of the dispersion was nearly unchanged after a storage test. Also, since flowability of the mixed dispersion was very satisfactory, the mixed dispersion could be used as a coating liquid or impregnation liquid for coating fluororesin without any trouble after 10 days.

### Example 14

Aqueous dispersion of fluororesin particle: A-2; 30 g

Metal oxide particle sol: B-5; 9 g

Mixing condition: room temperature and normal pressure

Stirring time: 60 minutes

Result: The prepared fluororesin-neodymium oxide mixed dispersion did not solidify/gelate, aggregate/precipitate, or separate phases for 7 days or more under storage conditions at room temperature, and viscosity of the dispersion was nearly unchanged after a storage test. Also, since flowability of the mixed dispersion was very satisfactory, the mixed dispersion could be used as a coating liquid or impregnation liquid for coating fluororesin without any trouble after 10 days.

When the prepared fluororesin-neodymium oxide mixed dispersion was used to form a coating film with the same procedure of the above Example 5, water contact angle of a coating film formed on glass substrate (drying: 1 50° C./30 minutes) or phenolic adhesive-applied SUS substrates (drying: 150° C./30 minutes) were 82.6 degrees and 115.2 degrees, respectively, and surface resistivity of a film formed by spin coating method was 2.8×10¹¹Ω/□.

### Example 15

Aqueous dispersion of fluororesin particle: A-3; 30 g

Metal oxide particle sol: B-5; 9 g

Mixing condition: room temperature and normal pressure

Stirring time: 60 minutes

Result: The prepared fluororesin-neodymium oxide mixed dispersion did not solidify/gelate, aggregate/precipitate, or separate phases for 7 days or more under storage conditions at room temperature, and viscosity of the dispersion was nearly unchanged after a storage test. Also, since flowability of the mixed dispersion was very satisfactory, the mixed dispersion could be used as a coating liquid or impregnation liquid for coating fluororesin without any trouble after 10 days.

From the above examples, all the above aqueous dispersions of fluororesin particle have good compatibility with sols such as titania, zirconia, lantana and neodymium oxide, and can easily form a mixed and uniform dispersion.

### Example 16

Aqueous dispersion of fluororesin particle: A-2; 30 g

Metal oxide particle sol: B-6; 10 g

Mixing condition: room temperature and normal pressure

Stirring time: 60 minutes

Result: The prepared fluororesin-ceria mixed dispersion did not solidify/gelate, aggregate/precipitate, or separate phases for 3 days or more under storage conditions at room temperature, and viscosity of the dispersion was nearly unchanged after a storage test. Also, since flowability of the mixed dispersion was very satisfactory, the mixed dispersion could be used as a coating liquid or impregnation liquid for coating fluororesin without any trouble after 4 days.

When the prepared fluororesin-ceria mixed dispersion was used to form a coating film with the same procedure of the above Example 5, water contact angle of a coating film formed on glass substrate (drying: 150° C./30 minutes) or phenolic adhesive-applied SUS substrates (drying: 150° C./30 minutes) were 116.9 degrees and 124.5 degrees, respectively, and surface resistivity of a film formed by spin coating method was 0.9×10¹¹Ω/□ (ohm/square).

### Example 17

Aqueous dispersion of fluororesin particle: A-3; 30 g

Metal oxide particle sol: B-6; 10 g

Mixing condition: room temperature and normal pressure

Stirring time: 60 minutes

Result: The prepared fluororesin-ceria mixed dispersion did not solidify/gelate, aggregate/precipitate, or separate phases for 3 days or more under storage conditions at room temperature, and viscosity of the dispersion was nearly unchanged after a storage test. Also, since flowability of the mixed dispersion was very satisfactory, the mixed dispersion could be used as a coating liquid or impregnation liquid for coating fluororesin without any trouble after 4 days.

### Example 18

Aqueous dispersion of fluororesin particle: A-2; 30 g

Metal oxide particle sol: B-7; 24 g

Mixing condition: room temperature and normal pressure

Stirring time: 60 minutes

Result: The prepared fluororesin-tin oxide mixed dispersion had pH of 9.8, did not solidify/gelate, aggregate/precipitate, or separate phases for 3 days or more under storage conditions at room temperature, and viscosity of the dispersion was nearly unchanged after a storage test. Also, since flowability of the mixed dispersion was very satisfactory, the mixed dispersion could be used as a coating liquid or impregnation liquid for coating fluororesin without any trouble after 3 days.

When the prepared fluororesin-tin oxide mixed dispersion was used to form a coating film with the same procedure of the above Example 5, water contact angle of a coating film formed on glass substrate (drying: 150° C./30 minutes) or phenolic adhesive-applied SUS substrates (drying: 100° C./60 minutes or 150° C./30 minutes) were 113.0 degrees, 121.1 degrees and 126.6 degrees, respectively, and surface resistivity of a film formed by spin coating method was 1.9×10¹¹Ω/□.

From the above Examples 16-18, it is understood that the aqueous dispersion of fluororesin particle A-2 has a good compatibility with ceria and neodymium oxide, and thus can be used to easily form a mixed and uniform dispersion. In addition, the aqueous dispersion of fluororesin particle A-3 has a good compatibility with ceria, and thus can be used to easily form a mixed and uniform dispersion.

### Advantage of the Invention

From the above Examples, it was obvious that a metal oxide mixed with a fluororesin has remarkable effects on inhibition of electrification of fluororesin and reduction of water contact angle, in other words, improvement and adjustment of non-wettability and non-tackiness.

### Application and Efficacy of the Invention

The invention can inhibit and control electrification of fluororesin and improve wettability and tackiness. This was confirmed with peeling of a coating film from a SUS substrate by a cross-cut adhesion test. More specifically, when the coating film formed by applying fluororesin-titania mixed dispersion on phenolic adhesive-applied SUS substrate (see Example 5) and the coating film formed by attaching PTFE membrane on the same SUS substrate using the same adhesive were cut in grid patterns with a knife and then peeled, it was found that the former was not peeled at all, but the latter was peeled easily and completely. This result shows that the wettability and the tackiness of the fluororesin would be improved remarkably by addition of a metal oxide such as titania to fluororesin.

Furthermore, it also shows that addition of the metal oxide enabled the surface modification and treatment for subsequent high functionalization and multi functionalization of fluororesin.

Further, while surface formed with only fluororesin is easily scratched in contact with hard materials since the surface is soft, the addition of this kind of metal oxide brought a benefit that not only hardens fluororesin and increases heat-resisting property thereof, but also makes the surface of fluororesin scratch resistant.

### INDUSTRIAL APPLICABILITY

The fluororesin-metal oxide mixed dispersion of the present invention is suitable as a coating liquid for coating surfaces of materials such as metals, carbons, plastics, glasses, ceramics, graphite, carbon fibers or carbonized fibers and the surface of product made of these materials, and as an impregnation liquid for fibers or powders of these materials.

Specifically, the mixed dispersion is used as a coating material for high functionalization and multi functionalization of surface of materials or products such as an electric wire, a thermometer, a sensor, a gasket or a packing.

1. A fluororesin-metal oxide mixed aqueous dispersion obtained by mixing aqueous dispersion of fluororesin particle, and particle sol of metal oxide with suitable pH value that is any one of titanium oxide, zirconium oxide, lanthanum oxide, neodymium oxide, cerium oxide, or tin oxide, wherein both said fluororesin particle and said metal oxide particle float and disperse without coagulation precipitation, gelation and solidification, and/or phase separation, wherein said floating and dispersion state is stably maintained under room temperature storage for three days or more, wherein water contact angle of a solid product obtained by evaporation and scattering of a solvent from the fluororesin-metal oxide mixed dispersion is 130 degrees or less, and surface resistivity is 2.0×10¹²Ω/□ (ohm/square) or less.

2. The fluororesin-metal oxide mixed aqueous dispersion according to claim 1, wherein said fluororesin-metal oxide mixed aqueous dispersion contains 3 to 100 times of fluororesin particle and 5 to 120 times of water in weight ratio with respect to the content of said metal oxide particle in said dispersion.

3. The fluororesin-metal oxide mixed aqueous dispersion of claim 1 or 2, wherein said suitable pH value of the metal oxide particle sol is 2.5-13.5 if the metal oxide is titanium oxide, 6.5-9 if the metal oxide is zirconium oxide, 7-10 if the metal oxide is lanthanum oxide, 7-10 if the metal oxide is neodymium oxide, 6.5-9.5 if the metal oxide is cerium oxide, or 9-11 if the metal oxide is tin oxide.

4. A method of manufacturing the fluororesin-metal oxide mixed aqueous dispersion according to either one of claim 1 or 2, comprising a step of mixing aqueous dispersion of fluororesin particle, and particle sol of metal oxide with suitable pH value that is any one of titanium oxide, zirconium oxide, lanthanum oxide, neodymium oxide, cerium oxide, or tin oxide under normal pressure at the temperature of 5 to 100° C., wherein the fluororesin particle is present at 3 to 100 times and water is present at 5 to 120 times in weight ratio with respect to the content of said metal oxide particle in the dispersion.

5. The method of claim 4, wherein said suitable pH value of the metal oxide particle sol is 2.5-13.5 if the metal oxide is titanium oxide, 6.5-9 if the metal oxide is zirconium oxide, 7-10 if the metal oxide is lanthanum oxide, 7-10 if the metal oxide is neodymium oxide, 6.5-9.5 if the metal oxide is cerium oxide, or 9-11 if the metal oxide is tin oxide.
